(19) United States
(12) Patent Application Publication
(10) Pub. No.: US 2011/0083658 A1
(43) Pub. Date: Apr. 14, 2011

(54) DISPOSABLE CHARCOAL LIGHTING APPARATUS

(75) Inventors: James Dudley, Sacramento, CA (US); Peter Dieterich, JR., San Geronimo, CA (US); Mike Simonian, San Francisco, CA (US); Maaike Evers, San Francisco, CA (US)

(73) Assignee: Design Annex, Sacramento, CA (US)

(21) Appl. No.: 12/683,314

(22) Filed: Jan. 6, 2010

Related U.S. Application Data
(62) Division of application No. 11/676,022, filed on Feb. 16, 2007, now abandoned.
(60) Provisional application No. 60/774,899, filed on Feb. 16, 2006.

(51) Int. Cl. A47J 37/07

(52) U.S. Cl. 126/25 B

(57) ABSTRACT

A portable, disposable apparatus for lighting charcoal or other flammable material contained therein. A central compartment generally in the shape of a tube extends from a bottom portion of the apparatus up through the center of the main body of the apparatus. An ignition strip extends within the tube. The apparatus is made of paper or paperboard or other lightweight flammable, yet durable, material. The apparatus is used by lighting the bottom of the ignition strip, which thereby starts a fire within the central compartment. The fire in the tube then ignites the charcoal within the main body of the apparatus. As the charcoal burns, the apparatus eventually burns away, leaving the burning charcoal in a pile.

### CROSS-REFERENCES TO RELATED APPLICATIONS

This application is a divisional application of U.S. patent application Ser. No. 11/676,022 filed Feb. 16, 2007 (Attorney Docket No. 026062-000210US) which claims the benefit of U.S. Provisional Application Ser. No. 60/774,899 (Attorney Docket No. 026062-000200US), filed Feb. 16, 2006, the disclosure of which is incorporated herein by reference in its entirety.

### BACKGROUND OF THE INVENTION

The present invention relates generally to systems and methods for igniting flammable material used for barbequing, and more particularly a portable, flammable charcoal holding and igniting apparatus.

Grilling food is a popular pastime. Many people have family get togethers and picnics that include grilling food. One of the more common ways to grill is to light charcoal and cook over the glowing embers. Ever since their development in the 1920's, charcoal briquettes have been messy, inconvenient and difficult to start. In order to start the fire for lighting the charcoal, lighter fluid is often used. However, if all the lighter fluid does not burn prior to cooking, then the food will often have a hint of lighter fluid flavor, which is generally an undesirable chemical-type taste. The recent development of instant-light charcoal briquettes solved several of these problems. However, there remains an entrenched consumer resistance to the chemical additives in which these instant-light briquettes are soaked; the chemical additives in instant-light briquettes tend to be smelly and impart objectionable flavors to grilled foods. This resistance has only compounded as the entire food industry continues to shift to increasingly natural foods which are naturally prepared.

One popular alternative is to light the charcoal in what is commonly referred to as a chimney. A chimney is generally a metal cannister with a perforated barrier separating the main body of the chimney from a smaller, bottom compartment. Charcoal is placed in the main body of the chimney while the smaller compartment is stuffed with a flammable material, often newspaper. The newspaper is lit and the flame extends through the perforated barrier and lights the charcoal. Once the coals are in a proper burning state, the chimney is emptied and the charcoal embers are spread for cooking over.

Unfortunately, if one is going to grill at a remote location, it can be inconvenient to transport the charcoal, at least one chimney, and material for lighting the charcoal. Indeed, a popular way in which to transport and burn charcoal at a remote location includes small bags of charcoal where one lights the bag in order to light the charcoal. Generally, the charcoal has already been treated with a lighter fluid-type substance at the charcoal packaging plant. Thus, this can still result in the undesirable altering of the flavor of the cooked food.

Accordingly, it is desirable to provide systems and methods that overcome the above and other problems.

### BRIEF SUMMARY OF THE INVENTION

The present invention provides a portable, disposable apparatus for lighting charcoal or other flammable material contained therein. A central compartment generally in the shape of a tube extends from a bottom portion of the apparatus up through the center of the main body of the apparatus to at least approximately half the height of the apparatus. In one aspect, an ignition strip such as a paperboard cross extends within the tube. In certain aspects, the apparatus is made of paper or paperboard or other lightweight flammable, yet durable, material. The bottom of the ignition strip may optionally include chemical-impregnated edges that are impregnated with a flammable material such as phosphorus. The apparatus is used by lighting the bottom of the ignition strip, which thereby starts a fire within the central compartment. Alternatively or additionally to the ignition strip, a separate flammable material such as wadded paper or newspaper may be included in the tube. The fire in the tube then ignites the charcoal within the main body of the apparatus. As the charcoal burns, the apparatus eventually burns away, leaving the burning charcoal in a pile.

In certain aspects, the apparatus is provided in combination with charcoal in the main chamber. A lid is provided in certain aspects to maintain the charcoal and soot in the main chamber and to reduce airborn sparks during the ignition process.

According to one aspect of the present invention a portable charcoal lighting apparatus is provided that typically includes a flammable containment member having walls defining a charcoal holding chamber, an ignition tube formed integrally with the containment member and positioned within the charcoal holding chamber, the tube defining an internal ignition chamber, and a moisture barrier that prevents or reduces the ability of water to penetrate the containment member walls. In certain aspects, the apparatus includes an ignition strip within the tube.

According to another aspect of the present invention a portable charcoal lighting apparatus is provided that typically includes a flammable containment member having walls defining a charcoal holding chamber, and an ignition tube formed integrally with the containment member and positioned within the charcoal holding chamber, the tube having tapered walls extending inwardly from a bottom portion of the containment member walls and defining an internal ignition chamber, wherein the internal ignition chamber is exposed to the atmosphere at a bottom portion of the containment member, wherein the bottom portion of the containment member includes one or more air channels that are inclined upwardly and inwardly toward the ignition tube. In certain aspects, the apparatus includes an ignition strip within the ignition tube.

According to yet another aspect of the present invention a portable charcoal lighting apparatus is provided that typically includes a flammable containment member having walls defining a charcoal holding chamber, and an ignition tube formed integrally with the containment member and positioned within the charcoal holding chamber, the tube defining an internal ignition chamber, wherein the ignition tube includes one or more fins or ribs that extend toward the walls of the containment member. The ribs or fins provide enhanced surface area contact with charcoal in the holding chamber.

According to yet another aspect of the present invention a portable charcoal lighting apparatus is provided that typically includes a base; and an ignition tube integrally formed with said base, wherein said tube extends vertically when the base is positioned on a horizontal surface.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIGS. 1-6 illustrate examples of a disposable charcoal lighting apparatus in accordance with various embodiments of the present invention.

FIG. 7 illustrates another example of an apparatus in accordance with an embodiment of the present invention.

FIG. 8 illustrates another embodiment, including chimney having inwardly tapered walls.

FIGS. 9a and 9b illustrate a chimney having ribs or fins according to one embodiment.

FIG. 10 illustrates an apparatus and also a pair of apparatus in a stacked relationship.

### DETAILED DESCRIPTION OF THE INVENTION

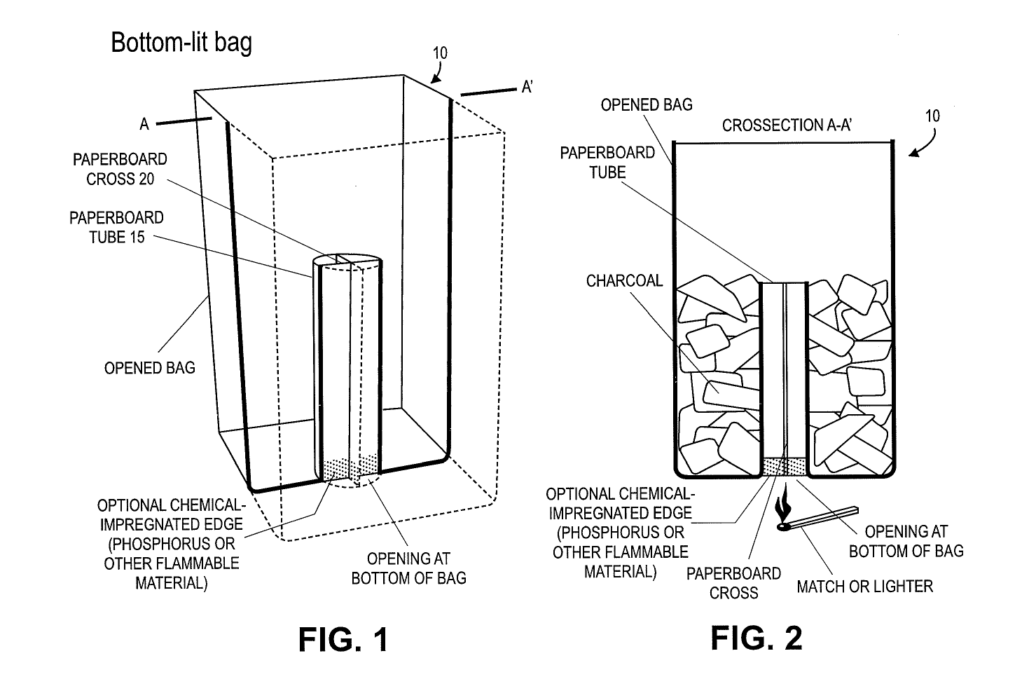

FIGS. 1 and 2 illustrate an example of a portable charcoal lighting apparatus 10 in accordance with one embodiment of the present invention. In this example, the apparatus 10 is generally in the form of a bag. The bag is preferably made of paper or paperboard or other lightweight flammable material with sufficient rigidity and strength to hold charcoal or other combustible material. A central tube 15 extends into the primary body of the bag. Central tube 10 defines an internal ignition chamber. Tube 10, in certain aspects, is integrally formed with and is made of the same material as the primary body of the apparatus 10, e.g., paper or paperboard, but it may be formed separately and may be made of a different material as desired. In certain aspects, charcoal is placed within the primary body. The charcoal may be placed within the primary body either by a user or by a manufacturer or seller of the apparatus.

In one embodiment, an ignition strip 20, such as a cross or other structure, preferably extends up into the central ignition chamber 15. The strip 20, in certain aspects, is made of the same material as the central ignition chamber 15, e.g., paper or paperboard, but it may be made of a different material as desired. The bottom edges of the strip 20 may be chemically impregnated with phosphorus or some other suitable type of flammable material if desired in order to aid in lighting the cross. Those skilled in the art will understand that other types of ignition material and/or arrangements may be placed within the central ignition tube in order to ignite tube 15 and thereby ignite the contents of the apparatus 10, e.g., charcoal.

Thus, in use, the bottom edges of the ignition strip are ignited, thus causing the strip to burn within the central ignition chamber. This in turn will cause the tube 15 to ignite and burn thereby lighting the charcoal within the main compartment.

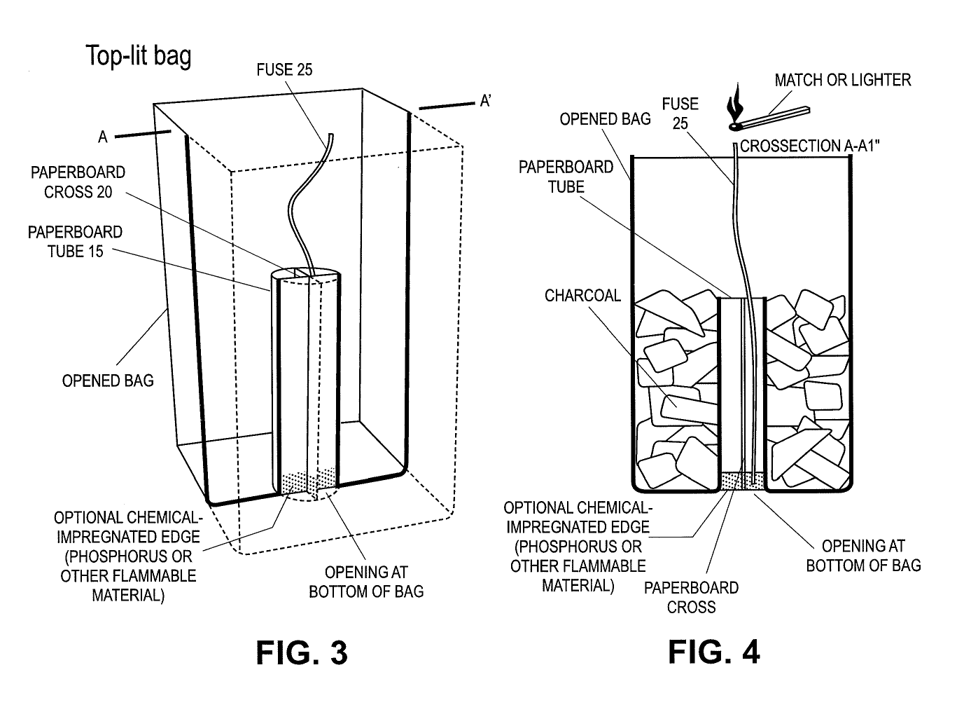

FIGS. 3 and 4 illustrate another example of an apparatus in accordance with an embodiment of the present invention. This embodiment is similar to the embodiment illustrated in FIGS. 1 and 2, however, a fuse 25 is provided that extends into the paperboard tube. The fuse allows the apparatus to be lit from the top. The fuse then burns down into the paperboard tube along the ignition strip thereby igniting them.

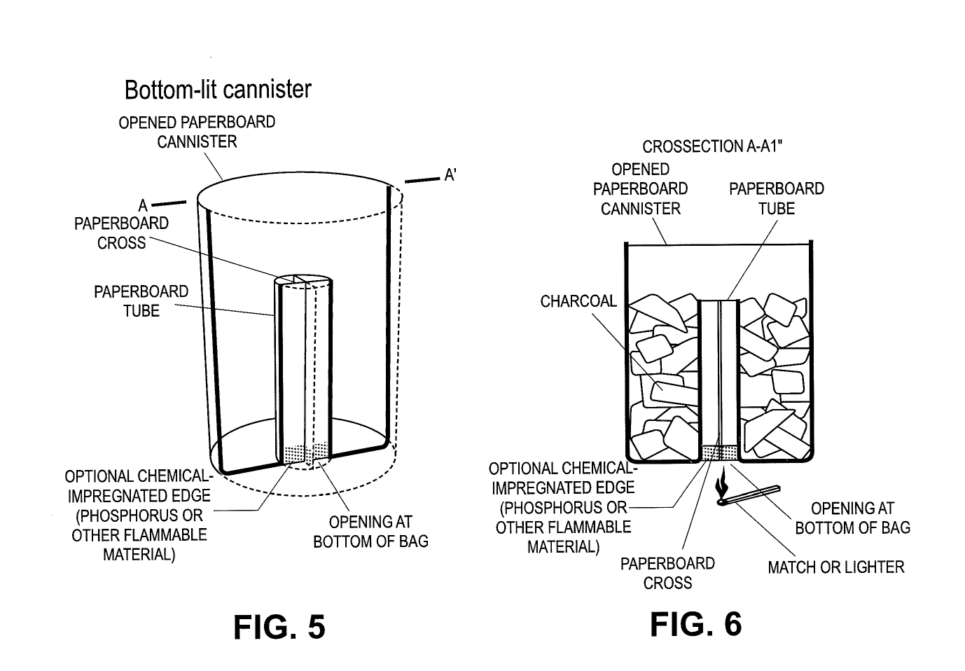

FIGS. 5 and 6 illustrate another example of an apparatus in accordance with an embodiment of the present invention. With this embodiment, the apparatus is in the shape of a cannister. Once again, preferably the cannister is made of paperboard or other lightweight combustible material.

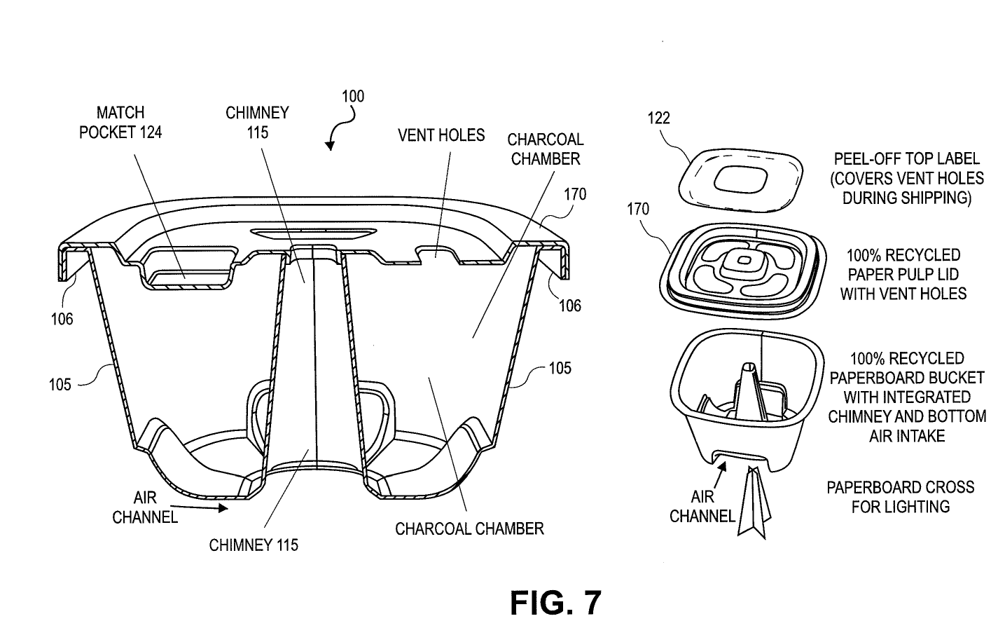

FIG. 7 illustrates another example of an apparatus in accordance with an embodiment of the present invention. As shown, apparatus 100 includes an outer wall 105 that defines a chamber for holding combustible material, e.g., charcoal, and a chimney 115 (e.g., tube) that defines a central ignition chamber. Chimney 115, in certain aspects, includes vertical walls. In other aspects, the chimney walls are tapered inwardly as shown. In one embodiment, the outer walls 105 are integrally formed with the chimney 115 to define a single continuous structure, e.g., using a pulp molding process to form the structure out of paper or paperboard. In alternate embodiments, the walls may be formed separately from the chimney and/or feet/floor structure, and may be made of a different material. A lid 120 is provided to cover the openings defined by walls 105. In one aspect, lid 120 includes one or more vent holes or perforations that function as air vents to facilitate ignition and updraft. A barrier 122 such as a removable seal or label is provided, in certain aspects, to cover vent holes during shipping and storage. This helps prevent contaminants and moisture from penetrating the interior of the apparatus 100 through the vent holes as well as prevent soot from escaping from the charcoal containment chamber.

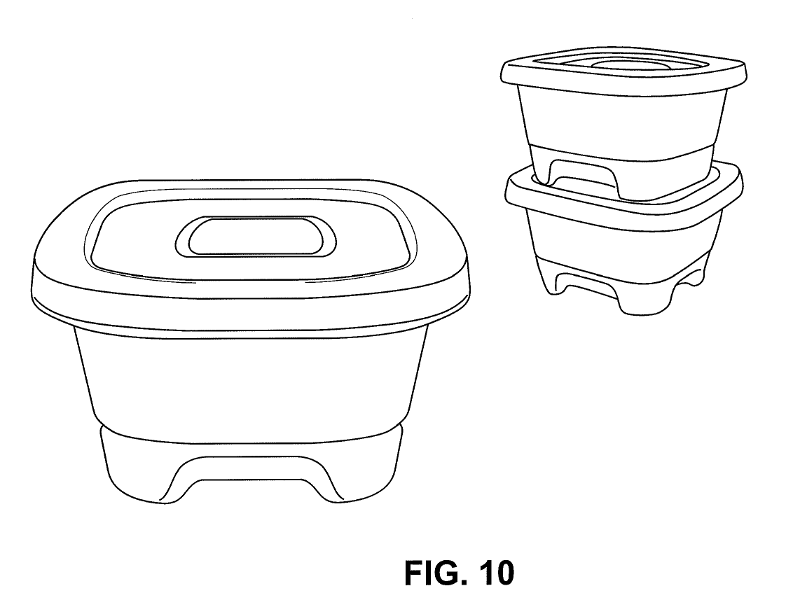

In one aspect, the perimeter portion of lid 120 is adapted to securely mate with rims 106 of the outer walls 105. In this manner, a user would have to exert a certain amount of force to remove lid 120 from rim 106. In another aspect, lid 120 is permanently affixed to rim 106, e.g., using a starch based glue or other adhesive substance or mechanism. Rim 106 also provides a means for a user to hold and carry apparatus 100 with or without lid 120. In certain aspects, lid 120 includes one or more indentions adapted to match the feet of another apparatus 100. In this manner, apparatus 100 may be stacked together with the feet of one apparatus fitting within the indentation(s) of a lid of a second apparatus (see FIG. 10). Stacking in this manner facilitates shipping and display of apparatus 100. In certain aspects, apparatus 100 includes sloping walls 105 to facilitate nesting of empty containers.

As shown in FIG. 7, in one aspect, a match compartment or pocket 124 is provided to hold a match or other ignition element. A removable barrier 122, or a separate removable barrier, will securely hold the match in place within pocket 124 until the barrier is removed by a user. Thus, in certain aspects, a self-contained charcoal lighting apparatus is provided. All a user needs to do is appropriately position the apparatus, peel off the top label (exposing the vent holes and the enclosed match), remove the match, and light the fuse or ignition strip. The apparatus does not need to be opened; the user simply lights the container exactly as they buy it from the store.

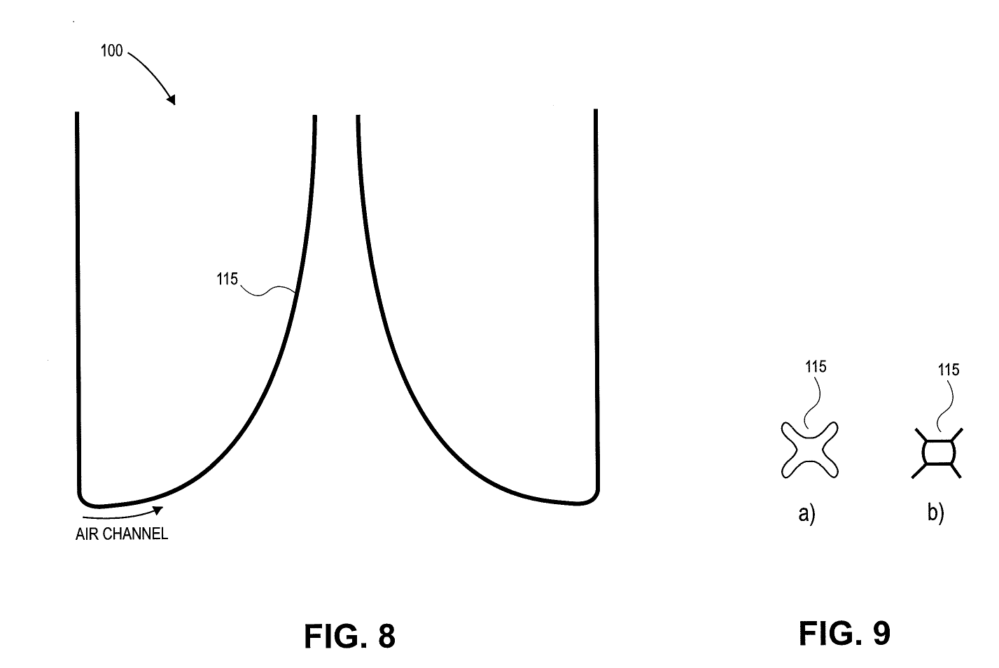

In one aspect, the floors of apparatus 100 include feet that define air channels therebetween to facilitate air flow from the outside of the apparatus to the (vertical) chimney 115. In one embodiment, these air channels are substantially horizontal proximal to the chimney 115 as shown in FIG. 7. FIG. 8 illustrates another embodiment, including air channels having an inward taper. With inwardly tapered air channels, the flames may be inclined towards the center of the vessel where they can ignite charcoal, rather than outwards where they may compromise the integrity of the vessel prematurely. In contrast, with the horizontal air channels, flames in the ignition process will more easily lap up the outside walls of the apparatus, thereby igniting one or more of the walls and causing the apparatus/vessel to collapse early in the ignition sequence. In one aspect, the chimney walls are tapered so as to form a venturi shape or trumpet shape as shown. In other aspects, the taper may include a linear taper beginning at the outer wall or extending horizontally from the inward wall and then tapering, either linearly, or with a trumpet shape. A taper may include different portions of linear taper (e.g., stepped with portions with differing slope). For example, the tapered air channels may meet with chimney walls having less of a taper or a larger taper or they may themselves have the same taper as the tapered chimney walls.

For example, in one aspect, charcoal is provided in the containment chamber and surrounds the internally formed, venturi-shaped ignition chamber. The ignition chamber is elevated from the base of the vessel by feet, e.g., half-inch feet, formed in the corners allowing free passage of air between the feet. When the ignition strip is lit from the exterior, cold air is drawn in from the base of the vessel between the feet and into the tapered ignition chamber. As the air enters and is constricted, it accelerates. This has the effect of “blowing” fresh air on the point of ignition which accelerates the combustion. The ignition chamber itself, which in certain aspects is formed of a thick recycled newspaper pulp then begins to rapidly combust and this combustion is spread to the surrounding charcoal.

In one embodiment, a natural, water soluble, fire retardant (e.g., sodium borate) is applied to portions of apparatus 100 to retard or slow combustion of those portions. In one aspect, for example, a retardant is applied to the base and side walls of apparatus 100, but not to the chimney portion defining the internal ignition chamber. In this manner, early ignition of the walls relative to the chimney will be prevented and the exterior walls of apparatus 100 will resist ignition and maintain structural integrity (e.g., maintain an upright position) longer during the ignition sequence.

In one embodiment, apparatus 100 includes a moisture barrier. In certain aspects, the moisture barrier is formed by impregnating the pulp material used to form apparatus 100. Impregnation may be performed before molding (e.g., by adding material to the pulp slurry) or after molding (e.g., by impregnating the formed apparatus). In certain aspects, paraffin, wax or starch, or other hydrophilic substance that can be absorbed by the paper or paperboard fibers, such as a petroleum product or natural waxes such as bees wax, is added to the pulp either in the slurry or by impregnating the pulp after molding. In another embodiment, a moisture barrier is provided by applying a separate physical barrier, e.g., a spray or film barrier, or a plastic wrap, to the exterior of the apparatus to prevent moisture and contaminants from penetrating apparatus 100. Examples of useful spray or film barrier materials include polylactic acid or other starch-based materials or spray-applied coatings. Providing a moisture barrier provides several advantages, including 1) reduce or eliminate absorption of moisture by apparatus 100 and its contents (this is particularly advantageous in humid climates), 2) reduced smoke output, 3) provide more dependable combustion, and 4) as a result of 3), the ability to provide thinner wall sections, which could lower weight and/or cost of the apparatus, but also would reduce the fly-away ash.

In one embodiment, chimney 115 includes one or a plurality of ribs extending radially outward as shown in FIG. 9a (when viewed from above). In another embodiment, chimney 115 includes one or more fins as shown in FIG. 9b. A ribbed or finned structure provides for more surface area of the chimney walls to extend into the charcoal containment chamber holding the charcoal, thereby providing more contact between the combusting chimney walls and the charcoal. Also, larger ribs or fins may be provided so that charcoal more distant from the center of chimney 114 has direct contact with the combusting chimney walls/ribs.

According to another embodiment, a stand alone ignition tube is provided. In this embodiment, a tube having a base acts as an igniter of charcoal placed around the tube. For example, in one aspect, the tube is semi-rigid and has a base that allows the tube to “stand” upright. The tube may have substantially vertical walls or the walls may be tapered as above. A user place charcoal around the tube and ignites the tube as above, either using a fuse or by lighting a bottom or top portion of an ignition strip located within the tube. Alternatively, the user my place a small bag of charcoal over the tube, with the tube puncturing the bag, so that the charcoal contained in the bag surrounds the ignition chamber defined by the tube. In certain aspects, the base of the tube includes perforations to facilitate air flow during ignition. The tube also includes one or more fins or ribs, as above, in certain aspects.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A portable charcoal lighting apparatus, comprising:
a flammable containment member having walls defining a charcoal holding chamber, wherein a top portion of the walls form a rim adapted to mate with a removable lid, and wherein the rim facilitates holding of the apparatus by a user;
an ignition tube formed integrally with the containment member and positioned within the charcoal holding chamber, the tube defining an internal ignition chamber;
a moisture barrier that prevents or reduces the ability of water to penetrate the containment member walls; and
a lid removably coupled with the rim, wherein the lid includes one or more perforations to allow for airflow between the internal ignition chamber and the atmosphere.

2. The apparatus of claim 1, wherein the containment member walls are made of a paper or paperboard and wherein the moisture barrier includes paraffin impregnated in the paper or paperboard.

3. The apparatus of claim 2, wherein the paraffin is impregnated into the paper or paperboard after formation.

4. The apparatus of claim 2, wherein the paraffin is included in a slurry used to form the paraffin impregnated paper or paperboard.

5. The apparatus of claim 1, wherein the moisture barrier includes a moisture-resistant material formed on the walls.

6. The apparatus of claim 5, wherein the moisture-resistant material includes one of polylactic acid, paraffin, wax, a starch-based product or a petroleum product.

7. The apparatus of claim 1, wherein the moisture barrier includes a plastic wrap applied to the walls.

8. The apparatus of claim 1, wherein the containment chamber and ignition tube are integrally formed.

9. The portable charcoal lighting apparatus of claim 1, further including an ignition strip located within the ignition tube.

10. The portable charcoal lighting apparatus of claim 1, wherein the containment member walls include a flame retardant material formed thereon or impregnated therein.

11. The apparatus of claim 1, further including a removable label that covers at least a portion of the lid having the one or more perforations.

12. The apparatus of claim 11, wherein the lid includes a pocket capable of holding a match or ignition device, such that when attached, the removable label forms an enclosure with the recession that holds a match or ignition device during shipping or storage of the apparatus.

13. The apparatus of claim 12, further including a match in the recession of the lid.
